(19) United States
(12) Patent Application Publication
(10) Pub. No.: US 2006/0151063 A1
(43) Pub. Date: Jul. 13, 2006

(54) Electric pencil sharpener

(75) Inventor: Tsz Bun Kok, Hunghom (HK)

Correspondence Address: LEYDIG VOIT & MAYER, LTD, 700 THIRTEENTH ST. NW, SUITE 300, WASHINGTON, DC, 20005-3960, US

(73) Assignee: Progressive Plastic Metal Stationery Products Manufactory Limited, Hunghom (HK)

(21) Appl. No.: 11/033,898

(22) Filed: Jan. 13, 2005

(51) Int. Cl. B43L 23/02; B43L 23/00

(52) U.S. Cl. 144/28.72; 144/28.5

(57) ABSTRACT

An electric pencil sharpener includes a casing, an electric motor located within the casing and a rotating blade driven to rotate by the electric motor. There is an aperture in the casing through which a pencil can be inserted for engagement with the blade. An activation sensor detects when a pencil has been inserted through the aperture and closes a circuit to drive the electric motor, and a deactivation sensor detects a sharpened tip of a pencil and opens the circuit to stop the motor.

### BACKGROUND OF THE INVENTION

The present invention relates to electric pencil sharpeners. More particularly, although not exclusively, the invention relates to an electric pencil sharpener having an automatic shut-off feature.

Electric pencil sharpeners are known. These comprise an electric motor driving a cutting implement such as a blade and a sensor to detect the presence of a pencil adjacent to the blade. When the sensor detects the presence of a pencil, the motor is activated to move the blade and thereby sharpen the pencil. A problem with such known pencil sharpeners is that it is not known precisely when the pencil is sufficiently sharpened and therefore the motor keeps turning and the pencil material is unnecessarily wasted.

### OBJECT OF THE INVENTION

It is the object of the present invention to overcome or substantially ameliorate the above disadvantage and/or more generally to provide an improved electric pencil sharpener having an automatic shut-off device that detects when the pencil is sufficiently sharpened and deactivates its sharpening operation.

### DISCLOSURE OF THE INVENTION

There is disclosed herein an electric pencil sharpener, comprising:

a casing,

an electric motor located within the casing,

a rotating blade driven to rotate by the electric motor,

an aperture in the casing through which a pencil can be inserted for engagement with the blade,

an activation sensor to detect when a pencil has been inserted through the aperture to close a circuit to the electric motor, and

a deactivation sensor for detecting a sharpened tip of a pencil to open the circuit.

Preferably, the deactivation sensor comprises a pushbutton adjacent to the blade against which the sharpened tip of a pencil can bear.

Preferably, the pencil sharpener further comprisesg a pivot bar against which the pushbutton bears to open a resilient circuit breaker.

Preferably, the pencil sharpener further comprises a spring to bias the pushbutton toward the aperture.

Preferably, the pushbutton moves linearly toward and away from the aperture.

Preferably, the pencil sharpener further comprises a gear train between the motor and the rotating blade.

Preferably, the pushbutton comprises a slot into which the blade extends.

### BRIEF DESCRIPTION OF THE DRAWINGS

A preferred form of the present invention will now be described by way of example with reference to the accompanying drawings, wherein:

FIG. 1 is a schematic perspective illustration of parts of an electric pencil sharpener including a deactivation pushbutton alongside the sharpening blade,

FIG. 2 is a schematic perspective illustration of parts of the electric pencil sharpener including an activation sensor to close a circuit to motivate the blade,

FIG. 3 is a schematic elevation of the deactivation pushbutton and associated electrical linkage,

FIG. 4 is a schematic inverted perspective illustration of parts of the electric pencil sharpener including its motor, gear train and battery compartment, and

FIG. 5 is a schematic plan view of various internal components of the electric pencil sharpener.

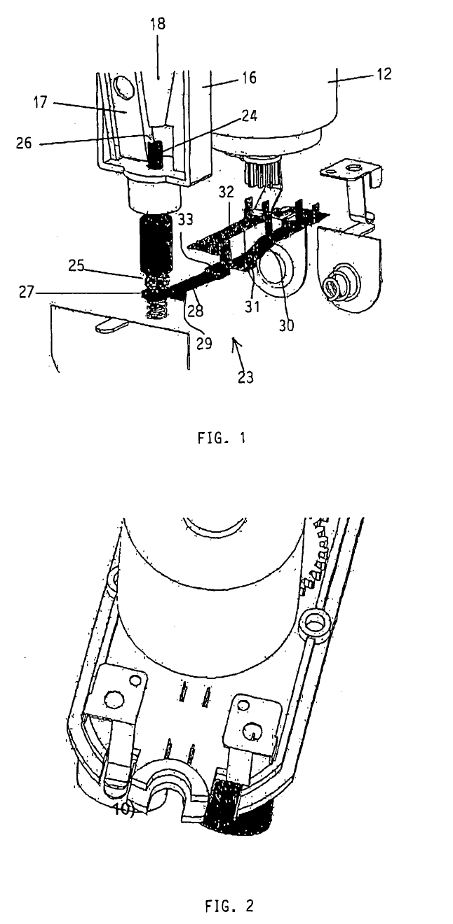

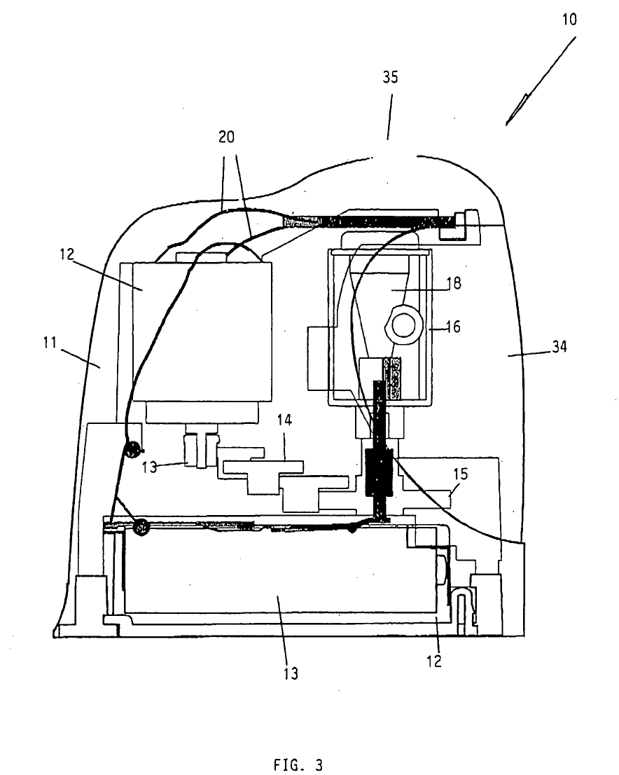

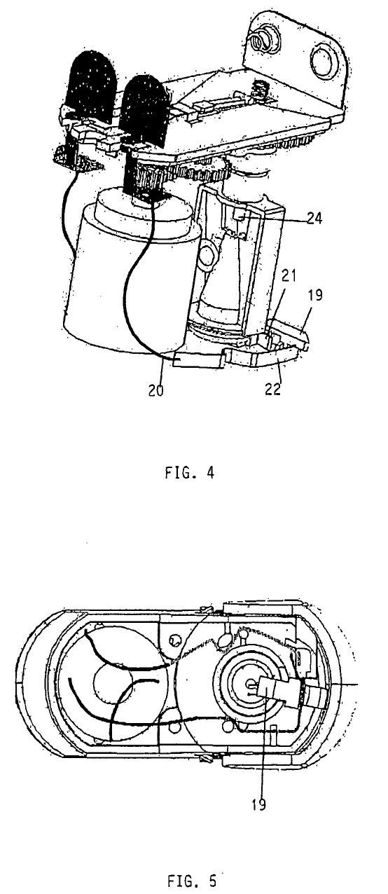

### DESCRIPTION OF THE PREFERRED EMBODIMENT

In the accompanying drawings there is depicted schematically an electric pencil sharpener 10 including a casing 11 in which there is a battery compartment 12 encasing a pair of AA batteries 13.

Located within the casing 11 is an electric motor 12 having an output pinion 13 driving a gear train 14. The gear train 14 has connected with its final gear 15 a rotating body 16 having a blade 17 affixed thereto. The blade extends tangentially into a conical pencil tip receiving cavity 18.

There is an opening 35 formed in the top of the casing 11 which is aligned with the cavity 18. The tip of a pencil can be inserted through the opening 35 to be received within the cavity 18 for sharpening by the blade 17 upon rotation of the body 16.

In order to cause rotation of the body 16, the motor 12 must first be activated. To this end, there is provided an activation sensor 19 beneath the opening 35. The sensor 19 acts as a switch to close a circuit 20 upon depression by the side of the pencil inserted through the opening 35. This circuit includes the batteries 13 and the motor 12. The sensor 19 is fixed upon a resilient metallic leg 21 which bears against another metallic leg 22 to close the circuit 20.

The circuit 20 also includes an automatic shut-off section 23 to open the circuit when a pencil is adequately sharpened by the blade 17. To this end, there is provided a pushbutton 24 at the bottom apex of the conical cavity 18. The pushbutton is mounted to move linearly in a vertical direction and is biased upwardly by a coil spring 25. The bottom of a coil spring 25 is mounted to a fixed internal part of the casing 11. The pushbutton 24 includes a vertical/longitudinal V-shaped slot 26 into which the lower-most portion of the sharp leading edge of the blade 17 is received.

Extending between intermediate coils of the spring 25 is a short end 27 of a pivot bar 28. The pivot bar 28 is mounted by a pivot pin 29 to the casing 11.

The circuit 20 includes a resilient metallic leg 13 that rests within a cradle 31 of another metallic leg 32. Legs 30 and 32 are thereby connected to one another forming part of the circuit. Upon depression of the pushbutton 24 against the spring 25, the short end 27 of the pivot bar 28 moves down so that the long end of the pivot bar 28 lifts up and bears upon the underside of a lip 33 formed at the end of leg 30. Upward movement of the leg 30 therefore occurs and the leg 30 moves away from cradle 31 to open the electrical circuit. As a result the motor 12 stops.

The graphite of a blunt or broken pencil will not reach the pushbutton 24, but once the pencil is adequately sharpened, it's graphite will extend down to press the pushbutton 24 to thereby deactivate the motor 12.

There is a snap-on cover 34 fitted to the casing 11 about the rotating body 16 and this can be removed to enable disposal of pencil shavings accumulated about the body 16.

It should be appreciated that modifications and alterations obvious to those skilled in the art are not to be considered as beyond the scope of the present invention. For example, instead of providing a pivot bar and metallic legs, the pushbutton 24 might extend directly from a momentary push off switch.

1. An electric pencil sharpener, comprising:
a casing,
an electric motor located within the casing,
a rotating blade rotated by the electric motor,
an aperture in the casing through which a pencil can be inserted for engagement with the blade,
an activation sensor detecting when a pencil has been inserted through the aperture and, in response, closing a circuit to supply power to the electric motor, and
a deactivation sensor for detecting a sharpened tip of a pencil and, in response, opening the circuit.

2. The pencil sharpener of claim 1, wherein the deactivation sensor comprises a pushbutton adjacent to the rotating blade against which the sharpened tip of a pencil can bear.

3. The pencil sharpener of claim 2, further comprising a pivot bar against which the pushbutton bears to open a resilient circuit breaker.

4. The pencil sharpener of claim 2, further comprising a spring biasing the pushbutton toward the aperture.

5. The pencil sharpener of claim 2, wherein the pushbutton moves linearly toward and away from the aperture.

6. The pencil sharpener of claim 1, further comprising a gear train coupling the motor to the rotating blade.

7. The pencil sharpener of claim 5, wherein the pushbutton comprises a slot into which the rotating blade extends.
